(19) United States
(12) Patent Application Publication
(10) Pub. No.: US 2013/0047682 A1
(43) Pub. Date: Feb. 28, 2013

(54) DOOR HANDLE LOCKING DEVICE FOR LOCKING TWO DOOR HANDLES TOGETHER

(71) Applicants: DeAnna Rae Kirkbride, Gypsum, KS (US); Edward Steven Shields, New Smyrna Beach, FL (US)

(72) Inventors: DeAnna Rae Kirkbride, Gypsum, KS (US); Edward Steven Shields, New Smyrna Beach, FL (US)

(21) Appl. No.: 13/222,878

(22) Filed: Aug. 31, 2011

(51) Int. Cl. E05B 65/00; E05B 67/00; E05C 17/32

(52) U.S. Cl. 70/51; 292/263

(57) ABSTRACT

A door handle locking device is used to lock two door handles against pivoting movement. The device includes first and second handle engaging structures with a hinged connecting member extending therebetween. The first handle engaging structure includes a first channel member and a crosspiece extending across an open side thereof. The first handle engaging structure is arranged to be placed over a first door handle with one side of the first channel member resting on top and the crosspiece extending behind the first door handle. The second handle engaging structure includes a second channel member arranged to be placed over a second door handle with one side of the second channel member resting on top and a hook element extending behind. An opening is provided in the second channel member for receiving a padlock for locking the second handle engaging structure to a corresponding opening in the second door handle.

### BACKGROUND OF THE INVENTION

1. Field of the Invention

The present invention relates generally to theft prevention devices and, in particular, to devices and methods for locking door handles to prevent unauthorized opening of doors, such as the doors of a military vehicle.

2. Description of the Related Art

Military vehicles, such as the Oshkosh M-ATV, are designed as armored fighting vehicles for harsh terrains. These vehicles are mine resistant, ambush protected (MRAP) with an armor configuration that protects the crew in treacherous environments.

Although these vehicles perform well in harsh terrains and treacherous environments, their armor configuration leaves them vulnerable to vandals and thieves when the vehicles are parked and left unattended.

There is a need for an improved locking system for securing the doors on such military vehicles in a closed, locked condition.

### SUMMARY OF THE INVENTION

It is an object of the present invention to provide a door handle locking device suitable for use with military vehicles to make the vehicles less vulnerable to vandals and thieves when the vehicles are unattended.

It is a further object of the present invention to provide a door handle locking device that locks front and rear door handles of a vehicle together to prevent unauthorized entry into the vehicle.

It is a further object of the present invention to provide a door handle locking device that is portable, easy to install and remove, foldable into a compact configuration for storage, durable, effective to prevent unauthorized entry into a vehicle, inexpensive to manufacture, and capable of a long useful life.

To accomplish these and other objects, the present invention provides a door handle locking device is used to lock two door handles together against pivoting movement. The device includes first and second handle engaging structures with a hinged connecting member extending between the handle engaging structures. The first handle engaging structure includes a first channel member and a crosspiece extending across an open side thereof. The first handle engaging structure is arranged to be placed over a first door handle with one side of the first channel member resting on top of the first door handle, and the crosspiece extending behind the first door handle. The second handle engaging structure includes a second channel member arranged to be placed over a second door handle with one side of the second channel member resting on top of the second door handle, and a hook element extending behind the second door handle. An opening is provided in the second channel member for receiving a padlock for locking the second handle engaging structure to a corresponding opening in the second door handle.

According to one aspect of the present invention, a door handle locking device for locking two door handles against pivoting movement is provided, comprising: first and second handle engaging structures and a connecting member extending between the first and second handle engaging structures; the first handle engaging structure comprising a first channel member and a crosspiece extending across an open side of the first channel member, the first handle engaging structure adapted to be placed over a first door handle with one side of the first channel member resting on top of the first door handle and the crosspiece extending behind the first door handle; and the second handle engaging structure comprising a second channel member, the second handle engaging structure adapted to be placed over a second door handle with one side of the second channel member resting on top of the second door handle, and an opening provided in the second channel member for receiving a padlock for locking the second handle engaging structure to a corresponding opening in the second door handle

According to another aspect of the present invention, a door handle locking system is provided, comprising: first and second door handles arranged for pivoting about first and second axes for opening and closing first and second doors, respectively, the first and second door handles extending from the first and second axes, respectively, away from each other; and a door handle locking device for engaging the first and second door handles and preventing the handles from pivoting about the first and second axes. The door handle locking device comprising: first and second handle engaging structures and a connecting member extending between the first and second handle engaging structures; the first handle engaging structure comprising a first channel member and a crosspiece extending across an open side of the first channel member, the first handle engaging structure arranged to be placed over the first door handle with one side of the first channel member resting on top of the first door handle and the crosspiece extending behind the first door handle; the second handle engaging structure comprising a second channel member arranged to be placed over the second door handle with one side of the second channel member resting on top of the second door handle, and an opening provided in the second channel member; and a padlock extending through the opening in the second channel member and a corresponding opening in the second door handle for locking the second handle engaging structure to the second door handle to thereby prevent removal of the door handle locking device from the first and second door handles.

Numerous other objects of the present invention will be apparent to those skilled in this art from the following description wherein there is shown and described an embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings. In the drawings:

FIG. 1 is an upside down rear elevation view of a door handle locking device according to the present invention.

FIG. 2 is a plan view of the door handle locking device.

FIG. 3 is a front elevation view of the door handle locking device.

FIG. 4 is a left side end view of the door handle locking device.

FIG. 5 is a right side end view of the door handle locking device.

FIG. 6 is a perspective view of the door handle locking device in an unfolded configuration for use.

FIG. 7 is a perspective view of the door handle locking device in a folded configuration for storage.

FIG. 8 is an elevation view of a door assembly for a military vehicle with which the door handle locking device of the present invention can be used.

FIG. 9 is an elevation view of the door handle locking device of the present invention installed on the door handles of the door assembly shown in FIG. 8.

FIG. 10 is a left side end view of the door handle locking device installed on a door handle.

FIG. 11 is a right side end view of the door handle locking device installed on a door handle.

FIG. 12 is a perspective view showing the process of installing the door handle locking device onto the door handles of the door assembly shown in FIG. 8.

FIG. 13 is a perspective view showing the door handle locking device installed on the door handles of the door assembly shown in FIG. 8.

### DETAILED DESCRIPTION OF THE INVENTION

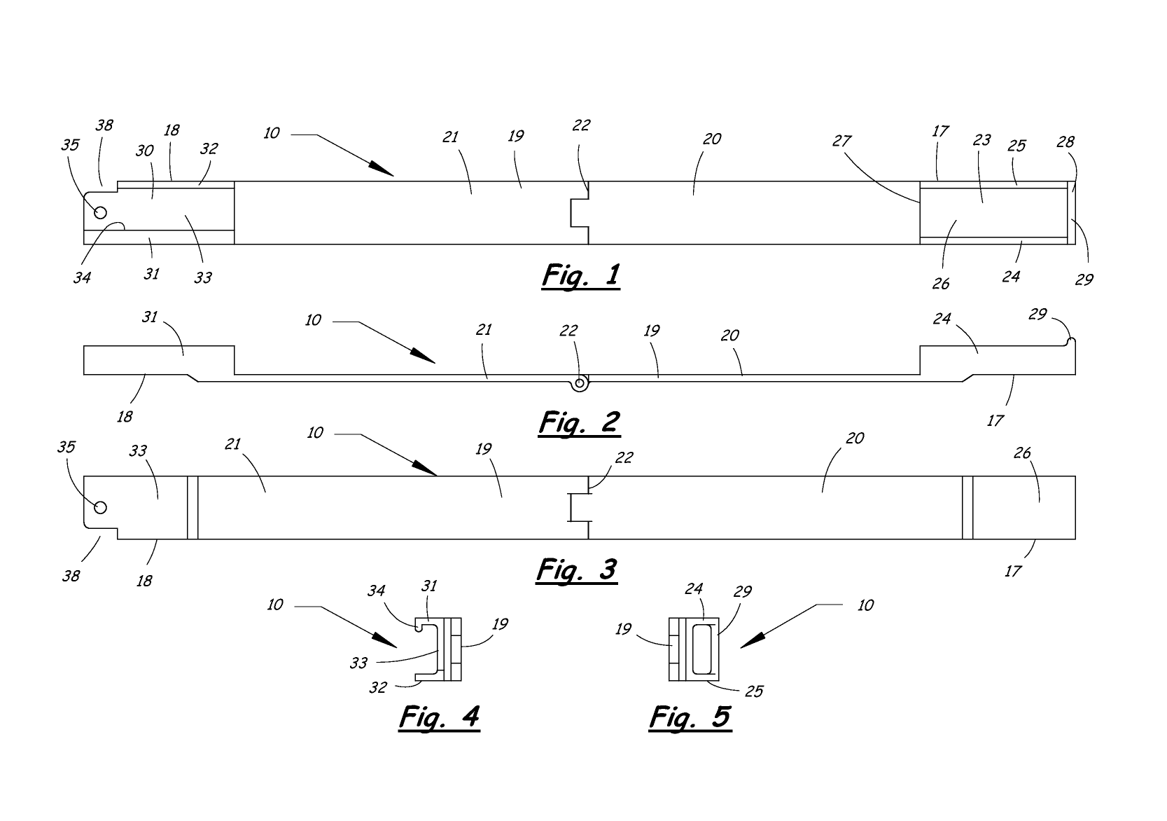

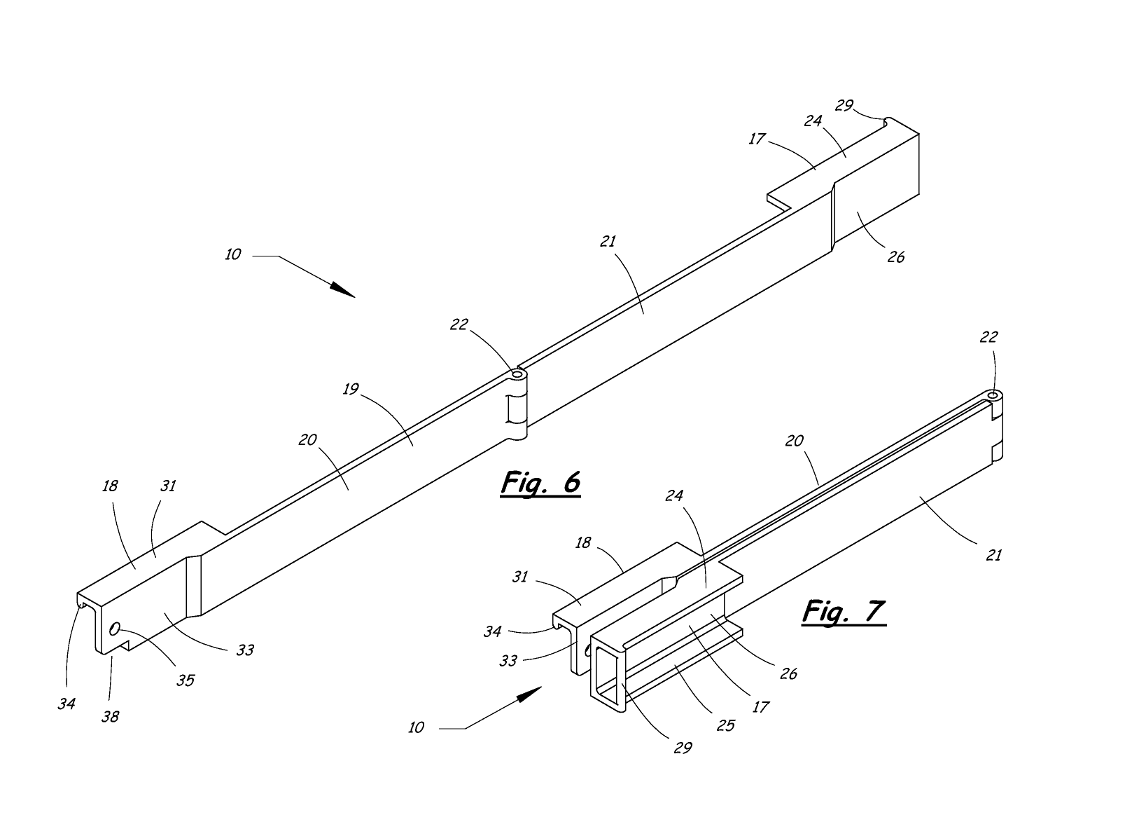

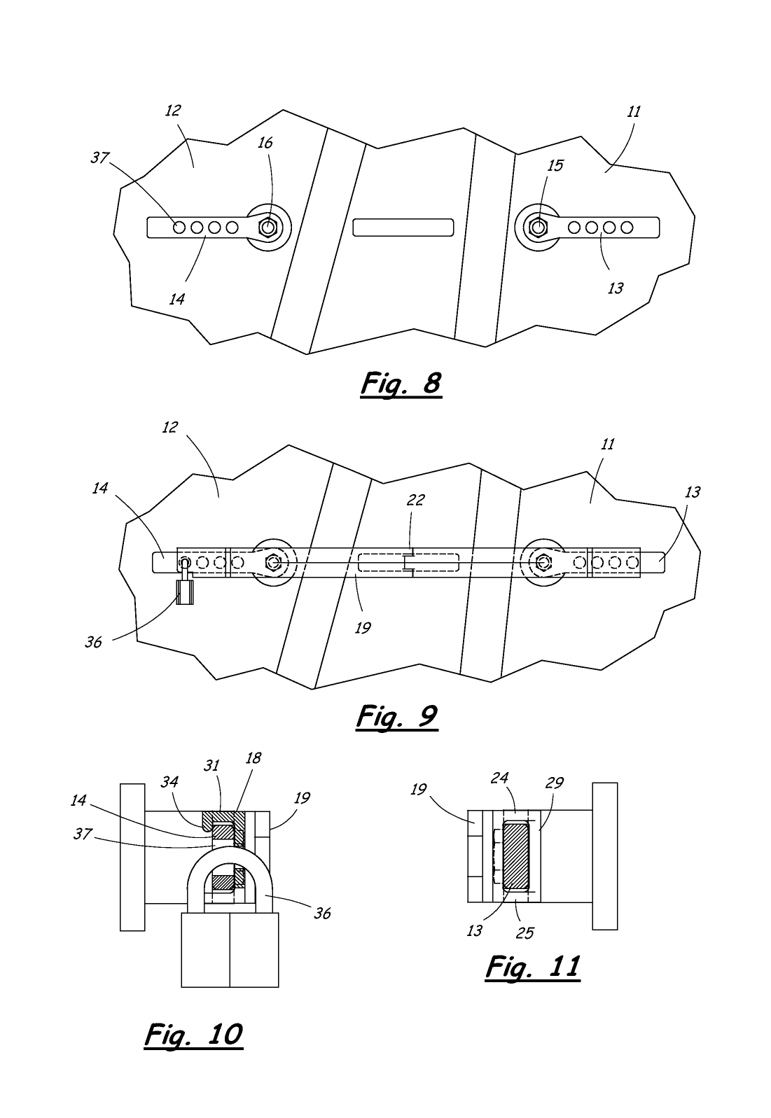

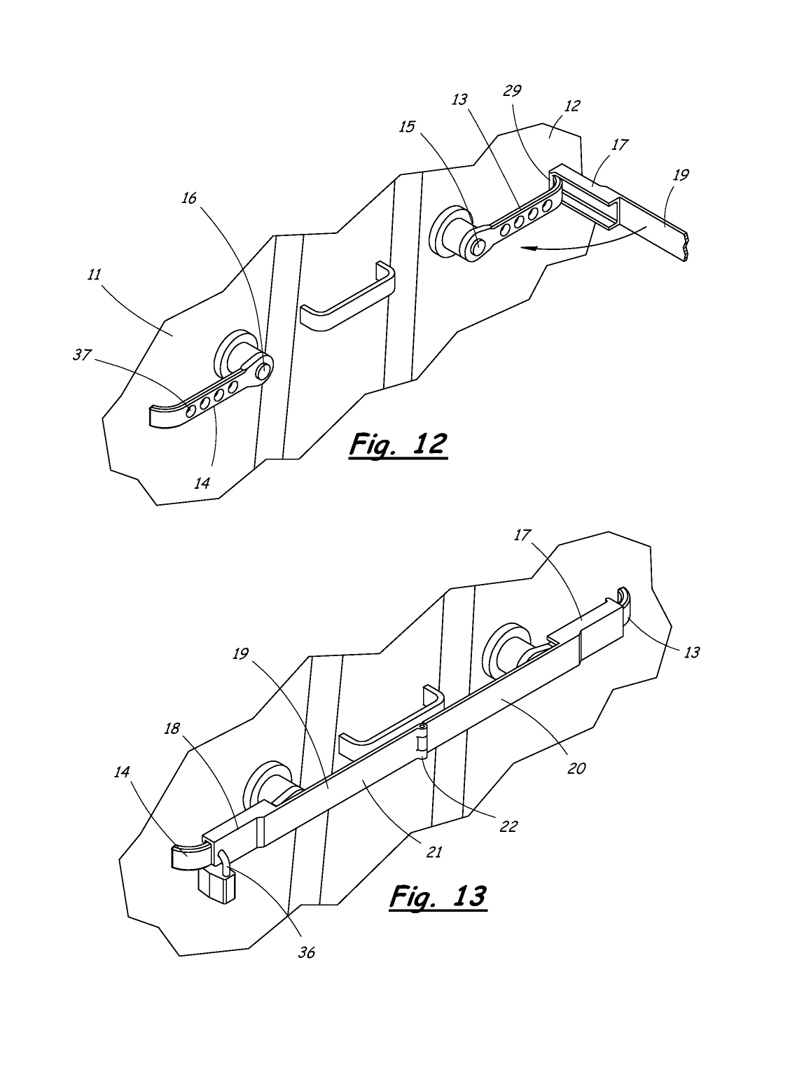

A door handle locking device 10 according to the present invention will now be explained in detail with reference to FIGS. 1 to 13 of the accompanying drawings.

The locking device 10 of the present invention was developed for use with door assemblies similar to what is illustrated in FIGS. 8 and 12. For example, such door assemblies are commonly found on military vehicles, such as the Oshkosh M-ATV. The rear doors 11 on such vehicles typically pivot about a hinge (not shown) at the rear of the door, and the front doors 12 pivot about a hinge (not shown) at the front of the door. The rear and front door handles 13, 14 are therefore located fairly close to each other. The door handles 13, 14 are each basically a piece of flat iron about 1.5 inches wide and 6 to 8 inches long that are attached to a shaft 15, 16 that protrudes out of the door 11, 12. The rear handle 13 extends horizontally rearwardly from the shaft 15 on the rear door 11, and the front handle 14 extends horizontally forward from the shaft 16 on the front door 12.

The door handle locking device 10 of the present invention is made to fit over both of the rear and front door handles 13, 14 and be padlocked to one of the handles to prevent either of the handles 13, 14 from being rotated. The door handle locking device 10 comprises a first handle engaging structure 17 located at one end, a second handle engaging structure 18 located at the other end, and a connecting member 19 extending between the first and second handle engaging structures 17, 18.

The connecting member 19 in the illustrated embodiment comprises first and second connecting members 20, 21 connected together by a hinge 22. The hinge 22 allows the device 10 to be folded between a compact configuration (illustrated in FIG. 7) for storage, and an extended configuration (illustrated in FIGS. 1 to 3 and 6) for use.

The hinge 22 has an axis of rotation perpendicular to the rotational axes of the door handles 13, 14. The connecting member 19 is rigid in a direction that allows the device 10 to resist movement of the two door handles 13, 14 about their respective axes.

The first handle engaging structure 17 includes a first channel member 23 having a U-shaped cross section with first and second sides 24, 25 extending at right angles to a base 26. The first and second sides 24, 25 are narrower than the base 26. The first channel member 23 has a proximal end 27 closest to the hinge 22 of the connecting member 19, and a distal end 28 opposite from the proximal end 27. A crosspiece 29 extends across an open side of the first channel member 23 at the distal end 28 of the channel member 23. The first handle engaging structure 17 is arranged to be placed over a first door handle 13 with one side 24 of the first channel member 23 resting on top of the first door handle 13, and the crosspiece 29 extending behind the first door handle 13.

The second handle engaging structure 18 includes a second channel member 30 having a U-shaped cross section with first and second sides 31, 32 extending at right angles to a base 33. The first and second sides 31, 32 are narrower than the base 33. The second channel member 30 has a hook element 34 that extends along a length of the second channel member 30 partway from the first side 31 of the second channel member 30 toward the second side 32 thereof. The second handle engaging structure 18 is arranged to be placed over a second door handle 14 with one side 31 of the second channel member 30 resting on top of the second door handle 14, and the hook element 34 hooked behind the second door handle 14 to help hold the device 10 in place on the second door handle 14 during use.

The first and second channel members 23, 30 are substantially parallel with the first and second connecting members 20, 21, respectively, and are also parallel with each other when the connecting members 20, 21 are in their extended configuration for use.

An opening 35 is provided in the base 33 of the second channel member 30 for receiving a padlock 36 for locking the second handle engaging structure 18 to a corresponding opening 37 in the second door handle 14. The second channel member 30 has a cutout area 38 defined by removing a portion of the second side 32 of the second channel member 30 adjacent to the opening 35 to accommodate the padlock 36.

The construction of the door handle locking device 10 of the present invention is explained above. The manner in which the device 10 is intended to be used will now be explained with particular reference to FIGS. 12 and 13 of the drawings.

With the first and second door handles 13, 14 both in their horizontal, latched positions, the first handle engaging structure 17 is placed over the first door handle 13 by passing the tip of the door handle 13 between the first channel member 23 and the crosspiece 29, as shown in FIG. 12. The device 10 is then moved by a combination of pivoting and sliding movements until the second handle engaging structure 18 is placed over the second door handle 14 with the hook element 34 hooked behind the second door handle 14, as shown in FIG. 13. The padlock 36 can then be inserted through the opening 35 in the second channel member 30 and the corresponding opening 37 in the second door handle 14 and locked in place. The padlock 36 functions to lock the second handle engaging structure 18 to the second door handle 14 to thereby prevent removal of the door handle locking device 10 from either of the first or second door handles 13, 14. In its installed and locked condition, the door handle locking device 10 prevents either of the first and second door handles 13, 14 from rotating, thereby effectively securing the doors 11, 12 against unauthorized opening.

The door handle locking device 10 of the present invention can be made of any suitable material having sufficient strength to prevent it from being bent or broken to gain access to the vehicle. For example, the device 10 can be made of high strength steel or titanium. It should also be understood that the device 10 can be made with or without a hinge in the connecting member 19 to allow the device 10 to be folded into a compact configuration for storage.

While the invention has been specifically described in connection with specific embodiments thereof, it is to be understood that this is by way of illustration and not of limitation, and the scope of the application should be construed as broadly as the prior art will permit.

What is claimed is:

1. A door handle locking device for locking two door handles against pivoting movement, comprising:
first and second handle engaging structures and a connecting member extending between said first and second handle engaging structures;
said first handle engaging structure comprising a first channel member and a crosspiece extending across an open side of said first channel member, said first handle engaging structure adapted to be placed over a first door handle with one side of said first channel member resting on top of the first door handle and said crosspiece extending behind the first door handle; and
said second handle engaging structure comprising a second channel member, said second handle engaging structure adapted to be placed over a second door handle with one side of said second channel member resting on top of the second door handle, and an opening provided in said second channel member for receiving a padlock for locking said second handle engaging structure to a corresponding opening in the second door handle.

2. The door handle locking device according to claim 1, wherein said first and second channel members each comprises a U-shaped cross section with first and second sides extending at right angles to a base, said first and second sides being narrower than said base.

3. The door handle locking device according to claim 2, wherein said second channel member further comprises a hook element extending partway from said first side of the second channel member toward the second side thereof, said hook element being arranged to hook behind the second door handle to hold the device in place on the second door handle during use.

4. The door handle locking device according to claim 3, wherein said hook element extends along a length of said second channel member.

5. The door handle locking device according to claim 2, wherein said opening for receiving a padlock is provided in said base of said second channel member.

6. The door handle locking device according to claim 5, wherein said second channel member comprises a cutout area with a portion of said second side of the channel member adjacent to said opening removed to accommodate said padlock.

7. The door handle locking device according to claim 1, wherein said connecting member comprises first and second connecting members connected together by a hinge, whereby said device can be folded about said hinge between a compact configuration for storage and an extended configuration for use.

8. The door handle locking device according to claim 1, wherein said first and second channel members are substantially parallel with each other when the device is placed over the first and second door handles.

9. The door handle locking device according to claim 1, wherein said first channel member has a proximal end and a distal end, and said crosspiece is located at said distal end.

10. The door handle locking device according to claim 1, wherein said connecting member is rigid in a direction parallel to a direction of movement of said two door handles to prevent pivoting movement of said two door handles.

11. A door handle locking system, comprising:
first and second door handles arranged for pivoting about first and second axes for opening and closing first and second doors, respectively, said first and second door handles extending from said first and second axes, respectively, away from each other; and
a door handle locking device for engaging said first and second door handles and preventing said handles from pivoting about said first and second axes, said door handle locking device comprising:
first and second handle engaging structures and a connecting member extending between said first and second handle engaging structures;
said first handle engaging structure comprising a first channel member and a crosspiece extending across an open side of said first channel member, said first handle engaging structure arranged to be placed over said first door handle with one side of said first channel member resting on top of said first door handle and said crosspiece extending behind said first door handle;
said second handle engaging structure comprising a second channel member arranged to be placed over said second door handle with one side of said second channel member resting on top of said second door handle, and an opening provided in said second channel member; and
a padlock extending through said opening in said second channel member and a corresponding opening in said second door handle for locking said second handle engaging structure to said second door handle to thereby prevent removal of said door handle locking device from said first and second door handles.

12. The door handle locking system according to claim 11, wherein said first and second channel members each comprises a U-shaped cross section with first and second sides extending at right angles to a base, said first and second sides being narrower than said base.

13. The door handle locking system according to claim 12, wherein said second channel member further comprises a hook element extending partway from said first side of the second channel member toward the second side thereof, said hook element being arranged to hook behind the second door handle to help hold the device in place on the second door handle during use.

14. The door handle locking system according to claim 13, wherein said hook element extends along a length of said second channel member.

15. The door handle locking system according to claim 12, wherein said opening for receiving a padlock is provided in said base of said second channel member.

16. The door handle locking system according to claim 15, wherein said second channel member comprises a cutout area with a portion of said second side of the channel member adjacent to said opening removed to accommodate said padlock.

17. The door handle locking system according to claim 11, wherein said connecting member comprises first and second connecting members connected together by a hinge, whereby said device can be folded about said hinge between a compact configuration for storage and an extended configuration for use, said hinge having an axis of rotation which is perpendicular to the first and second axes of said first and second door handles.

18. The door handle locking system according to claim 11, wherein said first and second channel members are substantially parallel with each other when the device is placed over the first and second door handles.

19. The door handle locking system according to claim 11, wherein said first channel member has a proximal end and a distal end, and said crosspiece is located at said distal end.

20. The door handle locking system according to claim 11, wherein said connecting member is rigid in a direction parallel to a direction of movement of said two door handles to prevent pivoting movement of said two door handles.
